(19) United States
(12) Patent Application Publication
(10) Pub. No.: US 2020/0367485 A1
(43) Pub. Date: Nov. 26, 2020

(54) MODULAR SPRAYING LEG

(71) Applicant: EXEL INDUSTRIES, PARIS (FR)

(72) Inventor: Josep GODIA, PARIS (FR)

(21) Appl. No.: 16/767,061

(22) PCT Filed: Nov. 27, 2018
(86) PCT No.: PCT/FR2018/053002

§ 371 Date: May 26, 2020

(30) Foreign Application Priority Data
Nov. 27, 2017 (FR) 1761224

(51) Int. Cl. A01M 7/00; B05B 1/20; B05B 15/652; B05B 15/16

(52) U.S. Cl. CPC A01M 7/0071; B05B 1/20; A01M 7/0014; B05B 15/16; B05B 15/652

(57) ABSTRACT

A spraying leg for an agricultural spraying machine, to an air-flow module for such a leg, and to an agricultural spraying machine provided with at least one such leg. Agricultural spraying machines which comprise spraying legs are known from the prior art, each spraying leg being provided with air diffuser and spray nozzle units, making it possible to send phytosanitary products driven by pulsed air onto the vegetation to be treated. A spraying nozzle is provided which can easily be adapted to the nature of the plants to be treated, in particular to the height and the configuration thereof. The spraying nozzle comprises at least one mounting, and a plurality of spraying modules attached to the mounting, each module forming an air-flow duct capable of each supporting at least one air diffuser and spray nozzle unit, the modules being connected to one another.

The present invention relates to a spraying leg for an agricultural sprayer, an air circulation module for such a leg, and an agricultural sprayer equipped with at least one such leg.

Agricultural sprayers comprising spraying legs are known from the prior art, each spraying leg being provided with air diffuser and spray nozzle assemblies, suitable for dispatching phytosanitary products carried by pulsed air onto the vegetation to be treated.

The present invention is intended to provide a spraying leg suitable for being readily adapted to the type of crops to be treated, namely in particular to the height thereof and to the configuration thereof.

For this purpose, the present invention provides a spraying leg, comprising at least one support, and a plurality of spraying modules fastened to this support, each module forming an air circulation duct suitable for each supporting at least one air diffuser and spray nozzle assembly, the modules being connected to one another by connection means.

According to other optional features of this spraying leg:
the parts of said support whereon said modules are fastened are hinged in relation to one another;
the hinges of said parts are motorised;
said connection means comprise bellows;
an air inlet corresponds to an air inlet of a box upstream from said leg and wherein an end opposite the air inlet is sealed by a removable cap.

The present invention also relates to an air circulation module for a spraying leg as described above, having the form of a one-piece box comprising at least one air intake orifice, at least one air outlet orifice, and at least one opening suitable for receiving an air diffuser and spray nozzle assembly.

According to other optional features of this air circulation module:
this air circulation module comprises parts forming a protective shield for said at least one air diffuser and spray nozzle assembly;
this air circulation module comprises fastening orifices on said support;
this air circulation module comprises upstream and/or downstream air curtain outlet orifices;
this air circulation module is formed of rigid or flexible polyethylene.

The present invention also relates to an agricultural sprayer, equipped with at least one spraying leg as described above.

Further features and advantages of the present invention will emerge in the light of the following description, and on studying the appended figures, wherein:

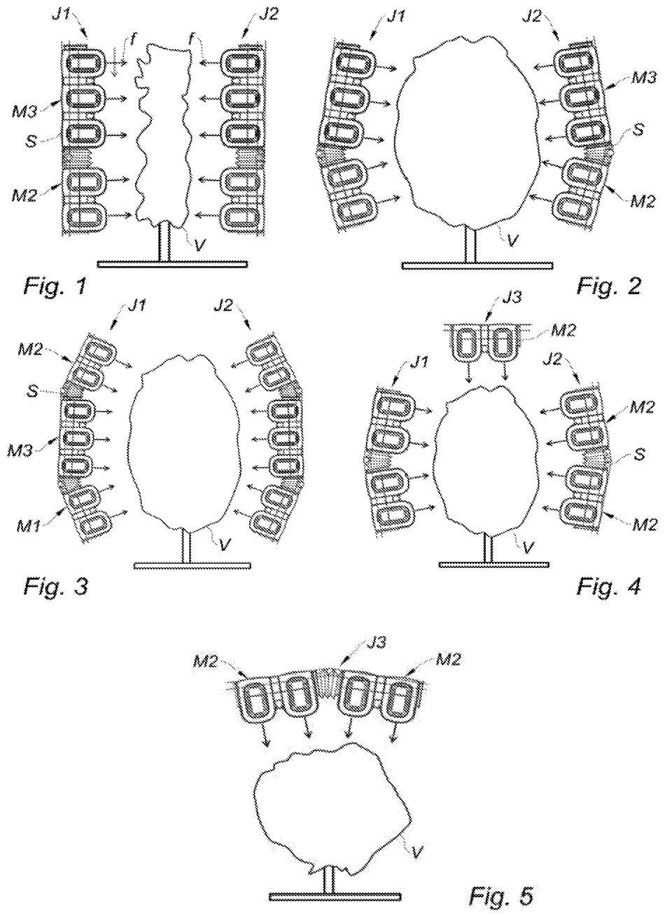

FIGS. 1 to 5 each represent schematically two spraying legs according to the invention borne by an agricultural machine (not shown), surrounding a crop to be treated, the spraying legs having different possible configurations,

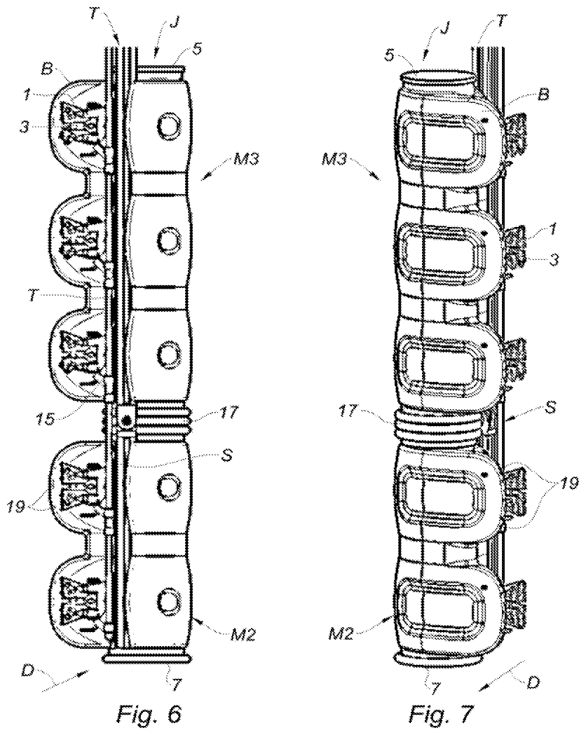

FIGS. 6 and 7 represent, in a perspective view, a possible configuration of a spraying leg according to the invention, viewed from two different angles, corresponding to the diagram represented in FIG. 1,

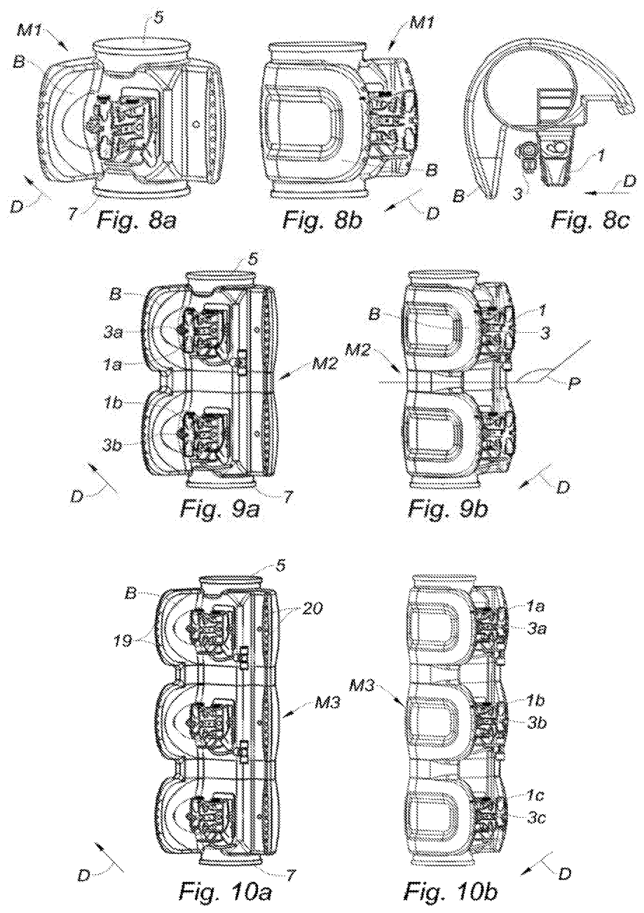

FIGS. 8a and 8b represent, in a perspective view and from two different angles, a spraying leg module according to the invention, of the type suitable for receiving a single air diffuser and spray nozzle assembly,

FIG. 8c represents this module in a top view,

FIGS. 9a and 9b represent, in a perspective view and from two different angles, a spraying leg module according to the invention, of the type suitable for receiving two air diffuser and spray nozzle assemblies,

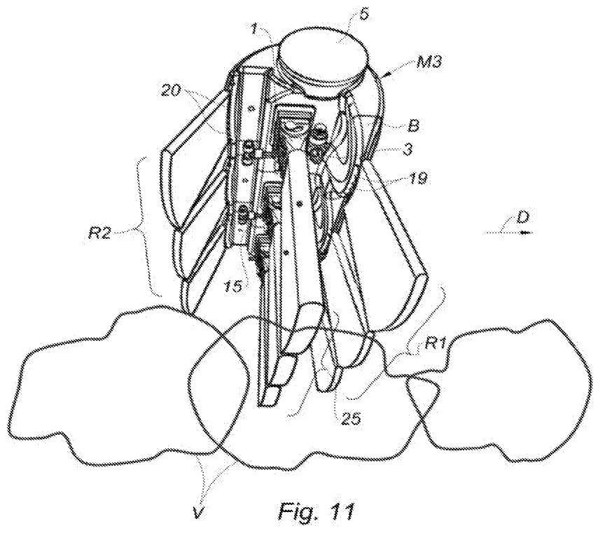

FIGS. 10a and 10b represent, in a perspective view and from two different angles, a spraying leg module according to the invention, of the type suitable for receiving three air diffuser and spray nozzle assemblies,

FIG. 11 represents, in a perspective view, a spraying leg module according to FIGS. 10a and 10b spraying a phytosanitary liquid on crops,

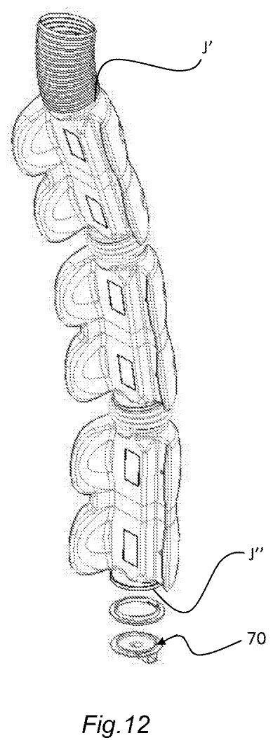

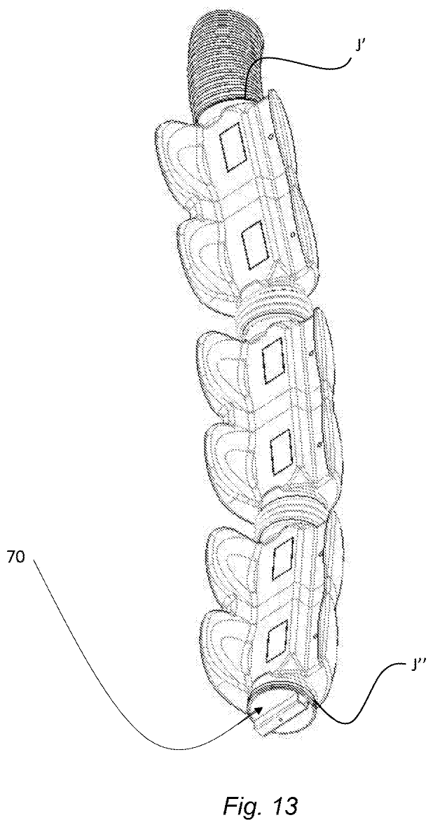

FIGS. 12 and 13 represent in a perspective view, a spraying leg according to an embodiment.

Reference is now made to FIGS. 1 to 5.

In FIG. 1, two spraying legs J1 and J2 according to the invention are presented, each including two modules M2 and M3 according to the invention forming air circulation ducts, mounted on a rigid support S.

These two spraying legs J1 and J2 are suspended from a supporting structure (not shown), in turn connected to an agricultural machine (not shown), this agricultural machine optionally being towed, or indeed self-propelled.

These two legs J1 and J2 are disposed on either side of a line of crops V to be treated by spraying, the spray jets being symbolised by the arrows fin FIG. 1.

With reference to FIGS. 6, 7, 9a, 9b, it can be seen that the module M2 is presented in the form of a hollow one-piece box, including orifices suitable for accommodating two air diffuser 1a, 1b and spray nozzle 3a, 3b assemblies.

In order to carry out spraying, the air flowing in the legs supplies propellant air to a nozzle. The propellant air enters via an inlet of the nozzle, traverses same from end to end and emerges via an opening at the outlet, in the form of an air jet directed towards the crops to be treated. The nozzle performs a function of shaping the air jet and dispensing same to the crops to be treated. The phytosanitary product is dispersed at the outlet opening of the nozzle so as to be carried or blown by the air jet into the foliage of the crops to be treated.

Such an air diffuser 1 and spray nozzle 3 assembly is also known as a nozzle or nozzle block and can be considered as an assembly configured to mix a phytosanitary product with the propellant air to form an aerosol, i.e. to spray and diffuse the aerosol.

Advantageously, this assembly is removable, preferably but not exclusively, in one piece from the wall bearing same to facilitate the maintenance thereof. This assembly engages preferably with a hole formed in the wall with which it engages in the assembled position, this assembly may be mounted on the hole and/or inside said hole.

The box M2 includes parts B forming a protective shield for each air diffuser 1 and spray nozzle 3 assembly: these shields, of substantially spherical shape, are disposed so as to protect these assemblies from collisions against the crops to be treated when the agricultural machine is moving, the travel and direction of this movement being indicated by the arrows D in FIGS. 6 to 11.

The box M2 includes an air intake orifice 5, and an air outlet orifice 7.

The box M2 has a hollow shape, and is formed preferably of polyethylene.

Also preferably, the box M2 is symmetrical with respect to a plane P (see FIG. 9b) intersecting same substantially at the centre thereof, such that it can be used indifferently for a right or left spraying leg.

The box M2 is connected to the support S by screws or rivets traversing this box.

As seen in FIGS. 6 and 7, the intake pipe T of phytosanitary liquid to be sprayed is fastened along the support S, and connected to the spray nozzle 3 by by-passes 15.

In the embodiment represented in FIGS. 1, 2, 6 and 7, the box M2 is topped with a similar box M3, represented in more detail in FIGS. 10a and 10b.

This box M3 differs from the box M2 in that it has a greater axial length, so as to be able to accommodate three air diffuser 1a, 1b, 1c and spray nozzle 3a, 3b, 3c assemblies.

As seen in FIGS. 6 and 7, the boxes M2 and M3 are connected to one another by a bellows 17, also optionally formed of polyethylene.

In the embodiment represented in FIGS. 1, 6 and 7, each support S is presented in the form of a rigid profile, for example made of aluminium, such that the two boxes M2 and M3 are immobile in relation to one another.

Alternatively, in the connection zone between these two boxes, where the bellows 17 is located, the profile S could have a hinge suitable for being oriented manually or using a motorised, optionally power-assisted, system, such that the inclination between the modules M2 and M3 could be modified, as seen in FIG. 2.

This makes it possible to mould the best possible way the shape of the crops V to be treated, and thus retain a substantially constant spraying distance with respect to these crops.

According to a further alternative embodiment (not illustrated), a support S is partially formed by the walls of the modules or partially integrated in these walls, for example by a reinforcement, the modules being presented in the form of a hollow one-piece box delimiting the air circulation ducts. In such a configuration, the walls of the boxes being self-supported, the modules are connected to one another by rigid intermediate supports.

In the same way as described above with a rigid profile, in the connection zone between two boxes, where the bellows 17 is located, a hinge may be envisaged to equip an intermediate support, the hinge being suitable for being oriented manually or using a motorised, optionally power-assisted, system, such that the inclination between the modules could be modified.

Each spraying leg delimits an air circulation channel between the successive modules and the associated connection zones, by supplying the air diffuser of each of the air diffuser and spray nozzle assemblies with air.

In a certain configuration, the spraying leg includes a proximal end and a distal end:
at the level of the proximal end J′ corresponds the air inlet of the leg which also corresponds to an air intake orifice of the most upstream box of the leg where the air arrives;
at the level of the distal end J″ thereof corresponds an air outlet orifice 7 which also corresponds to an air outlet orifice of the most downstream box of the leg, opposite the proximal end, said orifice being sealed by a cap 70 (see FIGS. 12 and 13).

According to a particular technical configuration, the cap 70 fitted on the distal end of the leg is removable. This particularly makes it possible to carry out quick disassembly to carry out quick cleaning thereof for example, and more effective than if the operator cleaned the inside of the leg only via the air intake orifice of the leg.

This cap 70 is preferably fastened to the box by screwing and preferably has a wall delimiting a cavity enabling a user to insert at least a part of their hand or a tool for handling the cap therein. It should be noted that other removable fastening means may be used such as clipping and/or form-fitting.

Moreover, the solution of handling the cap with a suitable tool offers the advantage of being able to form a lever arm further facilitating opening by an operator with less force.

Such a cavity particularly makes it possible to protect access by a user to the fastening means of the cap 70.

In FIGS. 8a to 8c, a module M1, shorter than the two previous modules M2 and M3, suitable for accommodating a single air diffuser 1 and spray nozzle 3 assembly, is represented.

Optionally, and as seen for example in FIG. 6, 7, 10a or 11, it may be envisaged that each of the modules M1, M2, M3, has additional air outlet orifices 19, 20, located respectively upstream and downstream from the air diffusers 1 with respect to the direction of travel D of the agricultural machine, these additional orifices 19, 20 being formed directly in the constituent material of the box.

Advantageously, it may be envisaged that these additional orifices 19, 20 be positioned so as to create respectively upstream R1 and downstream R2 air curtains (see FIG. 11), the inclination whereof is respectively of the order of 10° and 25° with respect to the air jet 25 generated by the air diffusers 1.

With reference now to FIGS. 3 to 5, further possible spraying leg configurations can be seen.

In FIG. 3, each leg J1, J2 comprises a central module M3 according to FIGS. 10a and 10b, on either side whereof two modules M2 according to FIGS. 9a and 9b are located.

In the embodiment represented in FIG. 4, each leg J1, J2 includes two modules M2 according to FIGS. 9a and 9b, and a third upper leg J3 also includes such a module M2.

In the embodiment represented in FIG. 5, an upper spraying leg J3 includes two modules M2 according to FIG. 10.

The method of use and the advantages of the present invention result directly from the above description.

The embodiment of each spraying leg using modules M1, M2, M3, makes it possible to configure this leg according to needs, i.e. particularly according to the shape of the crops to be treated.

This configuration may be performed in the factory, or indeed on the premises of the farmer, who can mount and dismount the modules at leisure, for example if they have different types of crop to be treated.

In the alternative embodiment where each spraying leg support S is hinged, the outline of the crops to be treated can be followed in the best possible way, and the dispensing of phytosanitary liquid on these crops thus optimised.

The presence of the shields B that are integral with each box M1, M2, M3, makes it possible to protect the air diffuser 1 and spray nozzle 3 assemblies against collisions with the branches of the crops to be treated.

It should furthermore be noted that these shields B define additional volumes inside each box M1, M2, M3 next to the air diffuser 1, thus making it possible to compensate for the volume occupied by these air diffusers inside the volume of each of these boxes.

These additional volumes make it possible to prevent the creation of air locks liable to disturb the air flow of the downstream air diffusers.

The upstream additional orifices 19 creating an upstream air curtain R1, have the effect of shaking and opening the foliage upstream from the spraying, thus facilitating spraying of the entire surface of the foliage with phytosanitary liquid.

The downstream additional orifices 20 creating a downstream air curtain R2, make it possible to collect the droplets of phytosanitary liquid that have bounced on the foliage of the crops treated, which has the advantage of preventing loss of phytosanitary liquid in the air, at the rear of the spraying legs with respect to the direction of travel of the agricultural machine.

1. Spraying leg (J1, J2, J3), comprising at least one support (S), and a plurality of spraying modules (M1, M2, M3) fastened to this support (S), each module (M1, M2, M3) forming an air circulation duct suitable for each supporting at least one air diffuser (1) and spray nozzle (3) assembly, the modules (M1, M2, M3) being connected to one another by connection means (17).

2. Spraying leg (J1, J2, J3) according to claim 1, wherein the parts of said support (S) whereon said modules are fastened are hinged in relation to one another.

3. Spraying leg (J1, J2, J3) according to claim 2, wherein the hinges of said parts are motorised.

4. Spraying leg (J1, J2, J3) according to claim 1, wherein said connection means comprise bellows (17).

5. Spraying leg (J1, J2, J3) according to claim 1, wherein an air inlet corresponds to an air inlet of a box upstream from said leg and wherein an end opposite the air inlet is sealed by a removable cap.

6. Air circulation module (M1, M2, M3) for a spraying leg (J1, J2, J3) according to claim 1, having the form of a one-piece box comprising at least one air intake orifice (5), at least one air outlet orifice (7), and at least one opening suitable for receiving an air diffuser (1) and spray nozzle (3) assembly.

7. Air circulation module (M1, M2, M3) according to claim 6, comprising parts forming a protective shield (B) for said at least one air diffuser (1) and spray nozzle (3) assembly.

8. Air circulation module (M1, M2, M3) according to claim 6, comprising fastening orifices on said support (S).

9. Air circulation module (M1, M2, M3) according to claim 6, comprising upstream and/or downstream air curtain outlet orifices (19, 20).

10. Air circulation module (M1, M2, M3) according to claim 6, formed of rigid or flexible polyethylene.

11. Agricultural sprayer, equipped with at least one spraying leg according to claim 1.
